(19) United States
(12) Patent Application Publication
(10) Pub. No.: US 2010/0168901 A1
(43) Pub. Date: Jul. 1, 2010

(54) MACHINE TOOL

(75) Inventor: Andreas Grozinger, Renningen (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, 80333 Munchen (DE)

(21) Appl. No.: 12/663,126

(22) PCT Filed: May 29, 2008
(86) PCT No.: PCT/EP2008/056619

§ 371 Date: Dec. 4, 2009

(30) Foreign Application Priority Data
Jun. 5, 2007 (DE) 10 2007 026 117.0

(51) Int. Cl. G05B 19/427; G05D 3/12; G05D 3/00

(52) U.S. Cl. 700/180; 700/192

(57) ABSTRACT

The invention relates to a machine tool, wherein the machine (1) comprises a control device (18) for controlling the movement of machine axes (3, 4, 5, 6, 8, 9) of the machine (1), the machine (1) comprising an operating device (11) having a longitudinal axis (12), wherein the device can be held by a person, wherein the spatial orientation of the longitudinal axis (12) is determined, wherein the movement of at least one machine axis is controlled by the control device (18) such that the spatial orientation of a tool (7) or of a work piece (2) substantially agrees with the spatial orientation of the longitudinal axis (12) of the control device (11). The invention enables easy alignment of a tool (7) and/or of a work piece (2) in a machine tool (1).

The invention relates to a machine tool.

Machine tools are generally used, by way of example, to machine workpieces by milling, drilling/boring, grinding and/or curling.

Machine tools, in particular five-axis milling machines, are operated with special hand-held operating devices, particularly when setting up the workpiece. In addition to the geometric axes X, Y and Z, the round axes required to orient the tool (in the case of head kinematics) or the workpiece (in the case of table kinematics) are commercially oriented via direction keys or handwheels. A frequent application is the alignment of the tool or of the workpiece perpendicular to the desired machining plane. In this context, commercially available machine tools have great difficulty in producing the desired orientation, that is to say the desired alignment, of the tool and/or the workpiece.

It is the object of the invention to provide a machine tool that enables the tool and/or the workpiece to be aligned easily.

This object is achieved by a machine tool wherein the machine has a control device for controlling the movement of machine axes of the machine, the machine having an operating device that can be held by a human hand and has a longitudinal axis, the spatial orientation of the longitudinal axis being determined, the movement of at least one machine axis being controlled by the control device in such a way that the spatial orientation of a tool or a workpiece substantially corresponds to the spatial orientation of the longitudinal axis of the operating device.

Advantageous designs of the invention follow from the dependent claims.

It turns out to be advantageous when the movement of at least two machine axes is controlled in such a way that the orientation of the tool or of the workpiece substantially corresponds to the spatial orientation of the longitudinal axis of the operating device, since then the workpiece and/or the tool can be quickly aligned in a simple way even with workpieces of complex construction.

It also turns out to be advantageous when the operating device has an actuating element, upon actuation of the actuating element the spatial orientation of the tool or of the workpiece being defined by assigning the spatial orientation of the longitudinal axis of the operating device to the spatial orientation of the tool. This measure enables the spatial orientation of the tool or of the workpiece to be defined easily by the operator.

It also turns out to be advantageous when the operating device has the actuating element, since then the movement of the tool or the workpiece can be prescribed manually.

It also turns out to be advantageous when the operating device has at least two transmitters for determining the orientation of the longitudinal axis. This enables an orientation of the longitudinal axis to be determined easily.

It also turns out to be advantageous when the machine tool has receivers for determining the orientation of the longitudinal axis. This enables the orientation of the longitudinal axis to be determined easily.

An exemplary embodiment of the invention is illustrated in the drawing and will be explained in more detail below. In the drawing:

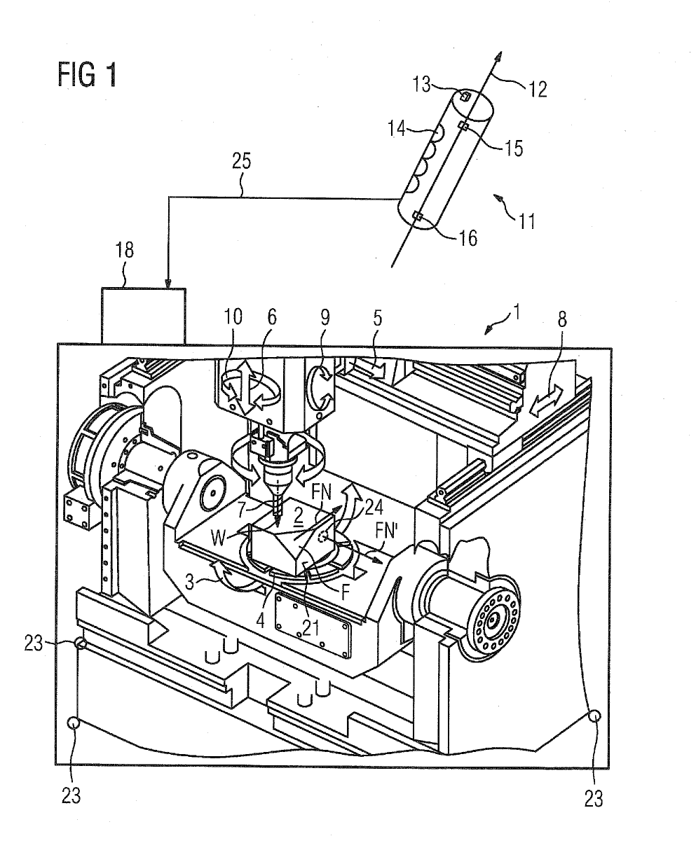

FIG. 1 shows a schematic of the inventive machine tool, and

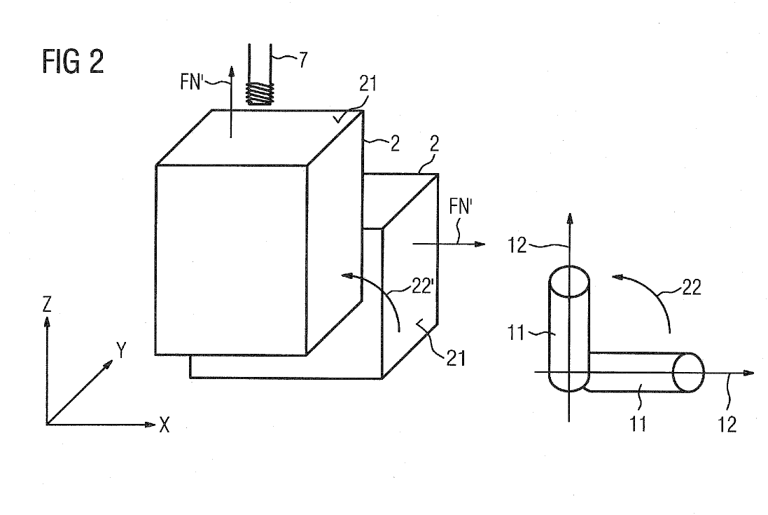

FIG. 2 shows a schematic of the principle of the invention.

FIG. 1 is a schematic of a machine tool 1 that has a control device 18 for controlling the movement of machine axes of the machine. In order to move a workpiece 2, the machine tool 1 illustrated in the context of the exemplary embodiment in this case has a first rotatable machine axis 3 and a second rotatable machine axis 4. Furthermore, in order to move a tool 7 that is designed as a miller in the context of the exemplary embodiment, the machine has a first linearly movable machine axis 5, a second linearly movable machine axis 6, a third linearly movable machine axis 8, as well as a third rotatable machine axis 9 and a fourth rotatable machine axis 10. The rotation axis of the tool 7 about which the tool 7 rotates is not regarded as a machine axis within the scope of the invention in this case. Among specialists, the rotatable machine axes are also denoted as round axes.

A workpiece 2 to be machined is clamped on the second rotatable machine axis 4. The workpiece 2 has a surface F that is to be machined and into which the aim is to mill a cutout running perpendicular to the surface F in the context of the exemplary embodiment. The workpiece 2 further has a so-called workpiece vector FN that is formed in the context of the exemplary embodiment as a surface normal vector running perpendicular to the surface F. The orientation of the tool 7 in space in this case forms a tool vector W what runs in the direction of the rotation axis of the tool 7 about which the tool 7 rotates.

If, as already stated above, the operator of the machine would like to mill into the surface F a cutout running perpendicular to the surface F, he needs to align the surface F, which forms a machining plane, by means of the first rotatable machine axis 3 and the second rotatable machine axis 4 such that for machining purposes the tool 7 can subsequently be moved vertically downward by means of the second linearly movable axis 6 in order to mill the cutout. The workpiece therefore needs to be moved by means of the first rotatable machine axis 3 and a second rotatable machine axis 4 such that the workpiece vector FN is spatially aligned in a fashion parallel to the rotation axis of the tool 7. In practice, this often faces the operator with a difficult task, since the machining plane, which is formed by the surface F in the context of the exemplary embodiment, cannot be directly pivoted accordingly, but can be moved only by means of rotational movements of the first rotatable machine axis 3 and the second rotatable machine axis 4. In practice, the alignment is frequently therefore associated with a substantial time outlay for rotating the surface even only approximately correspondingly so that it is at all possible to make a start on the milling machining.

The inventive machine tool therefore has an operating device 11 that can be held by a human hand and, in particular, can be grasped by the human hand. The operating device 11 has a longitudinal axis 12 with a corresponding orientation in space, as illustrated in FIG. 1. Furthermore, the operating device 11 has an actuating element 13 that can be actuated with the aid of the thumb, for example, as well as cutouts 14 for fingers. The operating device 11 is coupled to the control device 18 by wire or without wire in order to transmit data, and this is illustrated by an arrow 25 in FIG. 1. Furthermore, the operating device has a first transmitter 15 and a second transmitter 16, these being arranged in the context of the exemplary embodiment at two opposite ends of the operating device 11. The first transmitter 15 and the second transmitter 16 send signals for determining the orientation of the longitudinal axis 12 in space to three receivers 23, the spatial orientation of the longitudinal axis 12 being determined from the determined time difference between the received signals from the first transmitter 15 and the second transmitter 16.

In order to rotate the surface F as required, the operator firstly holds the operating device 11 to the machining plane, which is formed by the surface F in the context of the exemplary embodiment, such that the orientation of the longitudinal axis 12 is approximately perpendicular to the surface F, that is to say the orientation of the longitudinal axis 12 runs substantially parallel to the spatial orientation of the workpiece vector, which is formed by the surface normal vector FN in the context of the exemplary embodiment. Subsequently, the operator presses the actuating element 13, as a result of which the spatial orientation of the workpiece vector is coupled to the spatial orientation of the longitudinal axis 12. As long as the actuating element remains actuated, the movement of the first rotatable machine axis 3 and of the second rotatable machine axis 4 is controlled by the control device in such a way that the spatial orientation of the workpiece 2, which is represented by the workpiece vector FN, corresponds substantially, in particular corresponds to the spatial orientation of the longitudinal axis of the operating device. If the operating device 11 is, for example, rotated in space, and thereby the orientation of the longitudinal axis 12 in space is altered, the control device uses the kinematic transformation which is commercially integrated in the control device in any case, to control the first rotatable machine axis 3 and the second rotatable machine axis 4 precisely such that the spatial orientation of the workpiece 2 substantially corresponds, in particular corresponds to the spatial orientation of the longitudinal axis of the operating device the result being that the orientation of the workpiece follows the orientation of the longitudinal axis of the operating device. Consequently, by a simple rotational movement of the hand in which he aligns the operating device, and thus the longitudinal axis 12 parallel to the rotation axis of the tool 7, the operator 11 can rotate the surface F upward such that the latter is perpendicular to the rotation axis of the tool 7 after the movement operation.

If, as in the exemplary embodiment, the machine also has appropriate machines axes that also enable alignment of the tool, the orientation of the tool 2, which is represented by the tool vector W that is given by the rotation axis of the tool in the context of the exemplary embodiment, is coupled to the orientation of the longitudinal axis 12 of the operating device. To this end, the operator aligns the operating device 11 along the rotation axis of the tool 7 and actuates the actuating element 13. By appropriate rotation of the operating device 11 in space, he can subsequently rotate the tool 7 appropriately, the control device 8 correspondingly driving the two rotatable machine axes 9 and 10 such that the spatial orientation of the tool substantially corresponds, in particular corresponds to the spatial orientation of the longitudinal axis 12, and thus the spatial orientation of the tool 7 follows the rotational movement of the operating device 11.

It is rational in this case for the coupling of the movement of the operating device 11 to the workpiece or to the tool to be retained only for as long as the actuating element remains in the actuated state, in particular remains pressed. Consequently, for an extreme pivoting of the workpiece or of the tool it is possible for the operator to reposition the coupling to the workpiece or to the tool. The advantage of the invention resides in the assignment of a spatial machine movement to a corresponding movement of the operating device 11. According to the invention, the operator is able to move the “coupled” workpiece to be machined or the tool in any desired way on an imaginary sphere. If, as in the exemplary embodiment, the machine has a kinematics in which both the workpiece and the tool can be aligned by means of rotatable machine axes, the actuating element 13 can have a changeover switch that determines whether upon actuation of the actuating element 13 the tool 7 or the workpiece 2 is to be moved in accordance with the subsequent movement of the operating device 11. However, most commercially available machine tools (for example five-axis milling machines) permit either the alignment of the workpiece by means of two round axes (table kinematics) or the alignment of the correspondingly two tool by means of rotatable machine axes (head kinematics) that move the tool.

It is important for understanding the invention that the orientation of the tool does not necessarily, as in the exemplary embodiment, correspond to the orientation of the rotation axis of the tool and that the orientation of the workpiece need not necessarily correspond to the orientation of the surface normal vector, but that the orientation of the tool or of the workpiece is defined only upon actuation of the actuating element. At the moment of actuation of the actuating element, the orientation of the tool or of the workpiece is defined by assigning the spatial orientation of the longitudinal axis 12 of the operating device to the orientation of the tool or of the workpiece such that at the beginning the orientation of the tool or the workpiece corresponds by definition to the spatial orientation of the longitudinal axis 12 of the operating device. If, subsequently, the orientation of the longitudinal axis of the operating device is changed, for example by rotation of the hand, the workpiece on the tool is moved in such a way that the orientation of the tool or workpiece substantially corresponds, in particular corresponds to the spatial orientation of the longitudinal axis of the operating device.

Strictly speaking, it is not the case, as described at the beginning in the explanation relating to FIG. 1, that the workpiece or the tool has a spatial orientation from the beginning, that is to say a workpiece vector or a tool vector, but rather that the orientation of the workpiece or of the tool, and thus of the workpiece vector or the tool vector is not defined until the moment when the actuating element is actuated by assigning the spatial orientation of the longitudinal axis to the spatial orientation of the tool or of the workpiece at the moment when the actuating element is actuated.

The principle of the invention may also be explained once again with the aid of the schematic in accordance with FIG. 2. If a hole 24 (see FIG. 1) is to be milled laterally into the workpiece 2, it is sensible to align the operating device 11 perpendicular to the plane to be machined, that is to say to the lateral surface 21 of the workpiece 2, the orientation of the longitudinal axis 12 in this case being sensibly aligned in an X-direction by correspondingly using the operator's hand to hold the operating device. Upon actuation of the actuating element which, for the sake of clarity, is not illustrated in FIG. 2, the orientation of the workpiece is defined by assigning the orientation of the longitudinal axis 12 to the orientation of the workpiece 2, represented by the workpiece vector FN'. If the aim now is for the surface 21 to be machined to be rotated upward by 90° so that the hole 24 can be milled out by the tool 7, all that the operator need do is rotate the operating device 11 by 90° counterclockwise in the exemplary embodiment, this being illustrated by an arrow 22, for example by rotating the wrist. The surface 21 to be machined, this being illustrated by an arrow 22′, is rotated upward in accordance with the movement of the operating device 11 such that after the rotational movement the orientation of the workpiece vector, and thus the orientation of the workpiece, corresponds again to the instantaneous orientation of the longitudinal axis of the operating device 11. To this end, in accordance with FIG. 1 the operating device 18 drives the second rotatable machine axis 4 in such a way that the latter carries out a 90° rotation counterclockwise, and drives the first rotatable machine axis 3 in such a way that the latter likewise carries out the 90° rotation counterclockwise, it being possible, if appropriate, also to carry out movement of the two machine axes simultaneously. If the machine has yet further corresponding machine axes, it is also possible for yet more machine axes to be moved, in particular to be moved simultaneously. Thus, in the case of the inventive machine tool the operator need no longer consider how the movement prescribed by him by means of the operating device is carried out with the aid of machine axes available to the machine, that is to say the kinematics actually available.

Moreover, the invention also has the further advantage that if the control device knows the geometric shape of the workpiece and/or of the tool, the movement of the workpiece or of the tool can always be carried out by the control device such that no collision occurs between workpiece/tool and machine elements during the movement.

Furthermore, it may be remarked at this juncture that the spatial orientation of the longitudinal axis can, of course, also be determined in a different way than described in the exemplary embodiment. To this end, the operating element can also have other suitable means for determining the orientation of the longitudinal axis of the operating element.

The control device is usually designed as a CNC controller.

It may further be remarked that the actuating element need not necessarily be a component of the operating device, but can also, for example, be a component of an operating console for operating the machine tool.

1.-6. (canceled)

7. A machine tool, comprising:
a tool for machining a workpiece;
a control device controlling a movement of machine axes of the machine tool; and
an operating device configured to be held by a human hand and having a longitudinal axis,
said control device configured to control the movement of at least one of the machine axes in such a way that a spatial orientation of a member selected from the group consisting of the tool and the workpiece substantially corresponds to the spatial orientation of the longitudinal axis of the operating device.

8. The machine tool of claim 7, wherein the control device is configured to control the movement of at least two machine axes in such a way that the orientation of the member substantially corresponds to the spatial orientation of the longitudinal axis of the operating device.

9. The machine tool of claim 7, further comprising an actuating element which, when actuated, defines the spatial orientation of the member by assigning the spatial orientation of the longitudinal axis of the operating device to the spatial orientation of the member.

10. The machine tool of claim 9, wherein the actuating element is part of the operating device.

11. The machine tool of claim 7, further comprising determination means for determining the spatial orientation of the longitudinal axis of the operating device, said determination means including at least two transmitters provided on the operating device for generating signals commensurate with the spatial orientation of the longitudinal axis.

12. The machine tool of claim 11, wherein the determination means includes receivers provided on the machine tool and receiving the signals from the transmitters.

13. The machine tool of claim 12, wherein the receivers are configured to ascertain a time difference between the signals received from the transmitters to thereby determine the spatial orientation of the longitudinal axis.
